(19) United States
(12) Patent Application Publication
(10) Pub. No.: US 2009/0304049 A1
(43) Pub. Date: Dec. 10, 2009

(54) Structure Low Complexity for Implementing the Mpic Interference Canceller

(76) Inventors: Lahouari Fathi, Evry (FR); Marylin Arndt, Biviers (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/224,568

(22) PCT Filed: Feb. 21, 2007
(86) PCT No.: PCT/FR2007/050827

§ 371 Date: Mar. 16, 2009

(30) Foreign Application Priority Data
Feb. 28, 2006 (FR) 0650696

(51) Int. Cl. H04B 1/707

(52) U.S. Cl. 375/148; 375/E01.032

(57) ABSTRACT

This device is suitable for receiving from a multipath propagation channel a base-band spread-spectrum analog signal) conveying symbols. It has a structure with at least two stages each comprising a block for estimating said symbols and, with the exception of the final stage, a block for regenerating interference using the symbols estimated by the symbol estimating block of said stage. The signals are transmitted at the chip rate from one stage to the other and each of the interference regenerator blocks uses full Nyquist formatting.

### BACKGROUND OF THE INVENTION

The field of the invention is that of digital telecommunications.

The invention finds one particular application in the field of radio-frequency digital communication between a base station and a mobile terminal and notably in applications conforming to the evolution of third-generation mobile telephone systems known as HSDPA (High Speed Downlink Packet Access) systems defined by the UMTS Forum.

The HSDPA principle is based on fast adaptation of the link by assigning most resources to users whose channel conditions are favorable.

This standard authorizes QPSK and 16QAM modulation, 16QAM offering higher spectral efficiency.

However, 16QAM modulation is very sensitive to interference and its use requires advanced processing techniques in the receiver.

Known advanced processing techniques include the MPIC (multipath interference canceller) described in the paper by K. Higuchi, A. Fujiwara, and M. Sawahachi “Multipath interference canceller for high-speed packet transmission with adaptive modulation and coding scheme in W-CDMA forward link”, IEEE Journal on Selected Areas in Communications, Vol. 20, no. 2, pages 419-432, February 2002, below referred to as [Higuchi].

For HSDPA systems, the MPIC receiver offers better performance than the standard Rake receiver used in the basic UMTS.

The MPIC receiver is a non-linear multi-user receiver with a multi-stage structure. It belongs to the family of H-PIC (hard parallel interference canceller) receivers, in which a hard decision for estimating the symbols transmitted is taken at each stage and cancellation of the interference is effected for all the codes at the same time.

The MPIC operating principle regenerates the interference using the estimated symbols at the output of the current stage. That interference is then subtracted from the received signal and the resulting signal constitutes the input of the next stage. The interference is regenerated and cancelled on each path of the channel.

The following notation is used in the remainder of this document:
Tₛ: symbol time duration;
T_{c}: chip time duration;
Q: spreading factor (Q=Tₛ/T_{c});
S: oversampling factor (number of samples per chip time);
cₖ: spreading code k (k=1, . . . , K);
K: number of spreading codes allocated;
s: scrambling code;
\hat{d}: vector of the estimated symbols after a hard decision with \hat{d}=[\hat{d}₁^{T} . . . \hat{d}_{K}^{T}]^{T}, where \hat{d}₁, . . . \hat{d}_{K} are the vectors of the estimated symbols corresponding to the various codes after a hard decision;
\tilde{d}: vector of the estimated symbols after a soft decision with \tilde{d}=[\tilde{d}₁^{T} . . . \tilde{d}_{K}^{T}]^{T}, where \tilde{d}₁, . . . , \tilde{d}_{K} are the vectors of the estimated symbols corresponding to the various codes after a soft decision;
ψ(i): raised cosine (half-Nyquist) root-shaping pulse;
τ₁, . . . , τ_{L}: delay times caused by the various paths (expressed as numbers of samples);
h₁, . . . , h_{L}: complex gains of the various paths;
L: number of paths of the channel;
[.]^{T}: matrix transposition;
(.)*: complex conjugate.

FIG. 1 represents an MPIC receiver 12 with M stages (first stage 13, intermediate stages 14, and final stage 15) the structure of which is derived from a generic block diagram in [Higuchi].

The parameters used in this figure are defined as follows:
r(t): received base-band analog signal;
r(i): received base-band discrete signal after sampling at the rate T_{c}/S;
\hat{r}ₘₗ(i): estimated replica of the transmitted signal taking the path l (1≦l≦L) at the output of the stage m (1≦m<M);
\tilde{r}ₘ(i): input signal of the stage m (1≦m<M) on the path l (1≦l≦L)given by:

$${\tilde{r}}_{ml} ( i ) = r ( i ) - α {{\sum }_{l = 1}^{L}}_{l \neq l} {\hat{r}}_{( m - 1 ) l} ( i ) .$$

This signal is obtained by subtracting from the received signal r(i) all the replicas of the signal transmitted on the various paths of the channel with the exception of the replica corresponding to the path l in question;
α: rejection factor for interference introduced by the authors in [Higuchi] to control symbol estimation errors from one stage to another, where 0.5≦α≦1. This parameter increases for each stage to reach a value close to unity in the final stage.

An intermediate stage 14 (level m stage) of the MPIC receiver 12 with the standard structure is described below with reference to FIG. 2.

That stage 14 includes two main blocks, namely a symbol estimator block ET11 and an interference regeneration block ET12.

The symbol estimator block ET11 is a multiple-input multicode Rake receiver in which channel compensation is effected at the symbol timing rate Tₛ.

To be more precise, this symbol estimator block ET11 includes, for each path l, means 119 adapted to effect filtering adapted to the half-Nyquist root discrete shaping pulse of the input signal \tilde{r}ₘₗ(i) of this stage m on the path l.

It also includes, at the output of the filter means 119 adapted to shaping, means 112 for correcting the time delays τ₁, . . . , τ_{L} on the various paths and means 113 for sampling the corrected signals at the chip timing rate T_{c}.

As defined in the UMTS standard, the chip timing rate is 3.84 Mchip/s.

For each path, the signal at the output of the sampling means 113 is fed to the input of a multiplier 21 which multiplies the signal chip by chip by the complex conjugate of the scrambling code s* for descrambling it.

The signal from the multiplier 21 is fed to the input of a correlator (despreading filter) 111 corresponding to each of the codes C*₁ to C*ₖ of interest.

The signal at the output of each correlator 111 is fed to the input of decimation means 31 adapted to retain one sample every Q chips, which consists in effecting sampling in the analog domain at the symbol timing rate.

The symbol estimator block ET11 also includes means 114 for compensating the channel adapted, for each path l, to multiply the signal at the output of the decimation means 31 by the complex conjugate hₗ* of the gain of the corresponding channel.

It also includes, for each of the spreading codes cₖ, a summator 115 of the signals on the various paths.

The signal at the output of each summator 115, which constitutes a soft decision in respect of the symbols \tilde{d}₁, . . . , \tilde{d}_{K}, is fed to the input of a decision device 32 that depends on the type of modulation used and is adapted to give a hard estimate \hat{d}₁, . . . , \hat{d}_{K} of the symbols conveyed by the signal for the various spreading codes cₖ.

The interference regenerator block ET12 executes practically the same operations as in the transmit subsystem (for example a base station). This block includes in particular:
means 31′ for oversampling the estimated symbols \hat{d}₁, . . . , \hat{d}_{K} by a factor Q in order to convert them to the chip timing rate;
means 111′ for spreading the estimated symbols \hat{d}₁, . . . , \hat{d}_{K} by the respective codes C₁ to Cₖ;
a summator 115′;
a multiplier 116′ adapted to apply the scrambling code by multiplying the output signal of the summator 115′ by the sequence s chip by chip;
means 113′ for oversampling the signal at the output of the multiplier 116′ by a factor S in order to convert it to the fast timing rate;
means 119′ adapted to effect half-Nyquist shaping pulse filtering;
means 114′ adapted to weight the signal on each path, after shaping, by the coefficient of the corresponding channel h₁, . . . , h_{L}; and
means 112′ adapted to introduce the corresponding time delay τ₁, . . . , τ_{L}.

The last two operations are referred to as “channel filtering” and produce signals \hat{r}ₘₗ(i) that are estimated replicas of the signal transmitted on the various paths l of the channel at the fast timing rate at the output of the stage m.

In this structure, the signals are transmitted from one stage to another at the fast timing rate (sampling timing rate).

The structure of the first stage 13 is similar to that of the intermediate stage 14 from FIG. 2. The difference lies in the symbol estimator block, which is directly derived from the block ET11 by short-circuiting the input, i.e. by driving the inputs for the various paths by the same signal, which corresponds to the received base-band discrete signal r(i).

The person skilled in the art will realize that the last stage 15 of the MPIC receiver 12 does not include an interference regenerator block ET12 but only an estimator block similar to the symbol estimator block ET11 of the intermediate stages 14, that block further comprising an estimated symbol parallel/serial conversion block.

As described in [Higuchi], the MPIC receiver 12 described above provides a significant improvement in the bit error rate (BER) and the output bit rate.

However, implementing it complicates the arithmetic operations (multiplications, complex additions) by a factor of 5 to 25 over those of a standard Rake receiver used in the basic UMTS (see the complexity study below).

### OBJECT AND SUMMARY OF THE INVENTION

A main object of the present invention is to propose a low-complexity structure for the MPIC interference canceller.

To be more precise, the invention relates to a receiver for receiving from a multipath propagation channel an analog base-band spread-spectrum signal conveying symbols, said receiver having a structure with at least two stages each including a symbol estimator block and, with the exception of the final stage, an interference regenerator block using the symbols estimated by the symbol estimator block of said stage.

According to the invention, the signals are transmitted at the chip timing rate from one stage to another and each of the interference regenerator blocks uses full Nyquist shaping.

In the standard structure MPIC receiver described above with reference to FIGS. 1 and 2, half-Nyquist shaping is used in the interference regenerator block ET12 and a bank of filters adapted to half-Nyquist shaping is used at the input of the symbol estimator block ET11.

The invention effects shaping for interference regeneration using complete Nyquist (raised cosine) shaping instead of half-Nyquist shaping.

This feature has the advantage of eliminating the filter bank at the input of the symbol estimator block.

This approach combines in one and the same filter half-Nyquist shaping and the filter bank adapted to shaping.

The structure of the receiver of the invention reduces the proportion of processing effected at the fast timing rate, which is the most complex, and consequently reduces the overall complexity of the MPIC. This structure also reduces the memory load compared to the standard structure MPIC receiver.

Transmitting the signals between the various stages at the chip timing rate further reduces complexity. To be more precise, the operation of subtracting the interference from the received signal at the input of each stage is effected in the standard structure MPIC receiver 12 at the fast timing rate and in the receiver of the invention at the timing rate. This considerably reduces the number of untimed operations necessary for this receiver to operate.

In one particular embodiment of the invention, the symbol estimator block of the first stage consists of a multicode Rake receiver including a single despreading correlator filter for each of said codes and wherein channel compensation is effected at the chip timing rate.

This feature has the advantage that it reduces the complexity of the receiver as it requires only K correlators instead of the (K×L) correlators of the standard structure MPIC receiver described above with reference to FIGS. 1 and 2.

In the remainder of this document, the first stage of the receiver of the invention is referred to as a multicode Rake receiver with a T_{c} structure (for compensation at the chip timing rate), as opposed to the multicode Rake receiver of the standard structure MPIC receiver 12, in which compensation is effected at the symbol timing rate, referred to as the Tₛ structure.

In a correlated way, the invention is also directed to an iterative method of receiving from a multipath propagation channel an analog base-band spread-spectrum signal conveying symbols, said method including:
a step of obtaining a first estimate of the symbols corresponding to each of the codes;
a step of regenerating interference for each of said paths from the estimated symbols; and
an interference cancellation step of delivering a second estimate of the symbols by canceling the interference from the analog signal for each of said paths.

According to the invention, the interference is regenerated at the chip timing rate and the interference regeneration step uses full Nyquist shaping.

In one particular embodiment, the steps of the reception method are determined by computer program instructions.

Consequently, the invention is also directed to a computer program on an information medium, able to be executed in a receiver or more generally in a computer, and including instructions adapted to execute the steps of a reception method as described above.

That program can use any programming language and take the form of source code, object code or an intermediate code between source code and object code, such as a partially-compiled form, or any other desirable form.

The invention is also directed to a computer-readable information medium containing instructions of a computer program as referred to above.

The information medium can be any entity or device capable of storing the program. For example, the medium can include storage means such as a ROM, for example a CD ROM or a microelectronic circuit ROM, or magnetic storage means, for example a diskette (floppy disk) or a hard disk.

Moreover, the information medium can be a transmissible medium such as an electrical or optical signal, which can be routed by an electrical or optical cable, by radio or by other means. The program of the invention can in particular be downloaded over an Internet-type network.

Alternatively, the information medium can be an integrated circuit into which the program is incorporated, the circuit being adapted to execute the method in question or to be used in its execution.

### BRIEF DESCRIPTION OF THE DRAWINGS

Other features and advantages of the present invention emerge from the description given below with reference to the appended drawings, which show one non-limiting embodiment of the invention. In the figures:

FIG. 1, already described, represents a standard structure MPIC receiver;

FIG. 2, already described, represents one stage of the MPIC receiver from FIG. 1;

FIG. 3 represents one particular embodiment of a receiver of the invention;

FIG. 4 represents the first stage of the receiver from FIG. 3;

FIG. 5 represents an intermediate stage of the receiver from FIG. 3;

FIG. 6 represents the final stage of the receiver from FIG. 3;

FIG. 7 represents in the form of a flowchart the main steps of one particular embodiment of a reception program of the invention; and

FIGS. 8 to 11 show the improvement in complexity that can be obtained by means of the receiver of the invention.

### DETAILED DESCRIPTION OF ONE EMBODIMENT

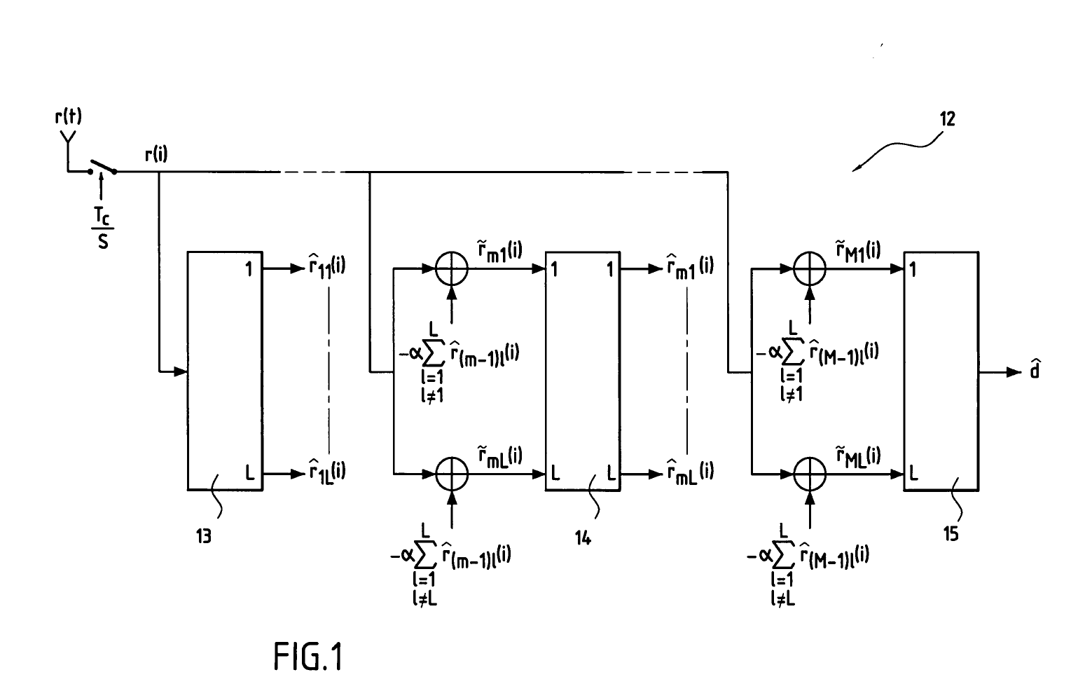

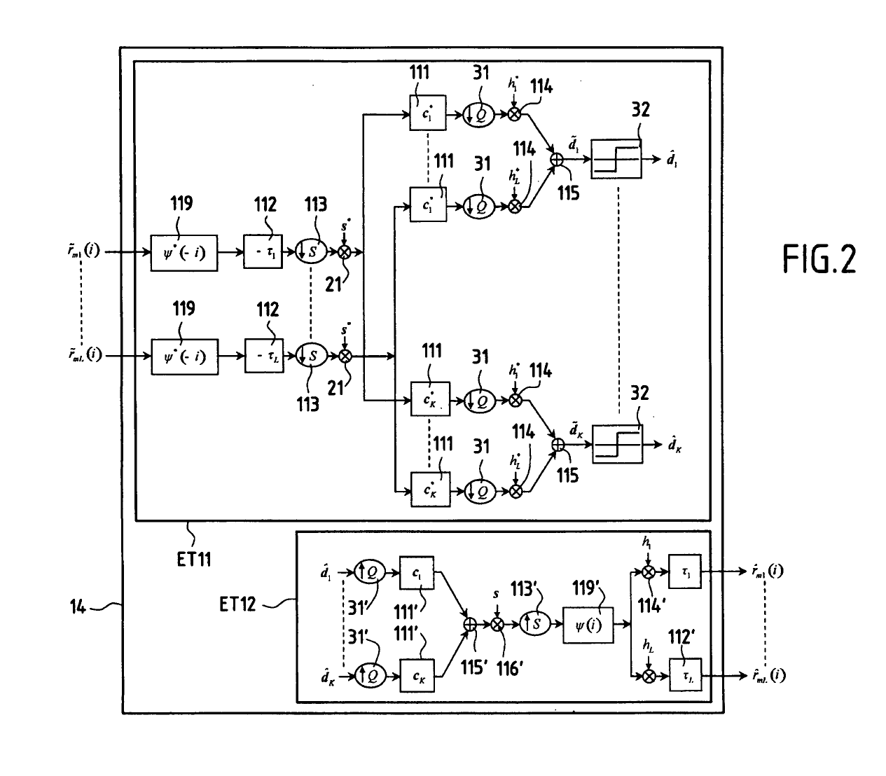

In the figures to be described below, elements already described with reference to FIGS. 1 and 2 retain the same references.

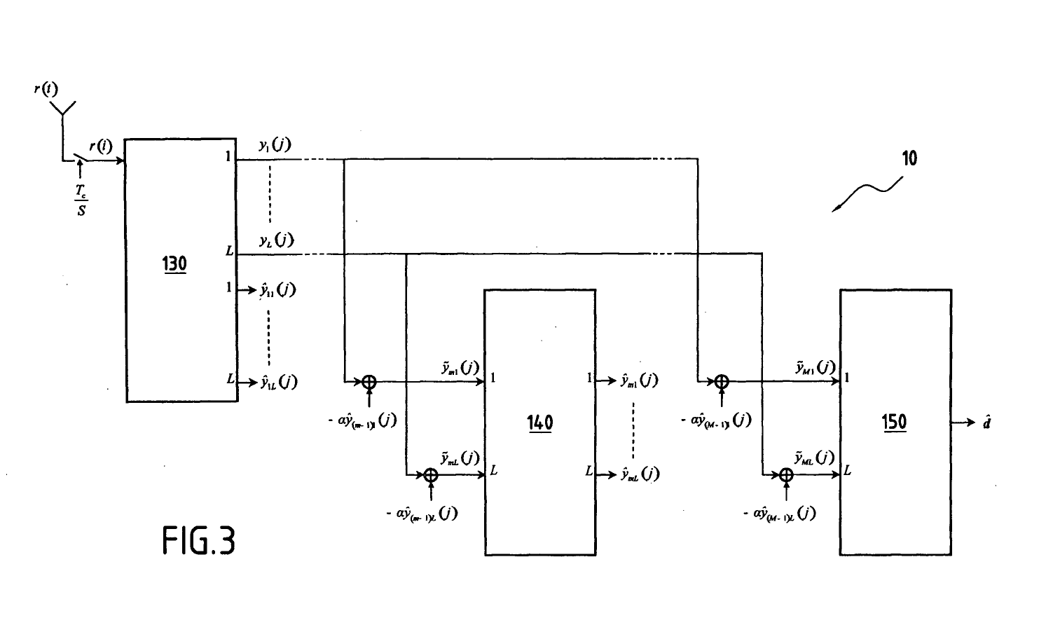

FIG. 3 represents the structure of one particular embodiment of a receiver 10 of the invention. In the embodiment described here, this receiver has M stages (first stage 130, intermediate stages 140, and final stage 150).

Unlike the standard structure MPIC receiver described with reference to FIGS. 1 and 2, in the receiver 10 of the invention signals are transmitted from one stage to another at the chip timing rate.

The input-output signals are defined as follows:
y₁(j) is the signal received at the chip timing rate after filtering adapted to the half-Nyquist shaping pulse and correction of the delay on the path l, obtained from the equation:

yₗ(j)=r(i)*ψ*(−i)*δ(i+τₗ)|_{i=jS},

in which δ(i) is the unit pulse (digital Dirac pulse), * represents the digital convolution operation, and |_{i=jS} represents the operation of sampling at the chip timing rate.
\tilde{y}ₘₗ(j) is the input signal at the chip timing rate of the stage m on the path l, obtained from the equation:

\tilde{Y}ₘₗ(j)=yₗ(j)−α\tilde{y}₍ₘ₋₁₎ₗ(j),

where α is the interference rejection factor and ŷ₍ₘ₋₁₎ₗ(j) is the regenerated interference signal at the chip timing rate at the output of the stage (m−1) on the path l, using full Nyquist shaping;
ŷ₍ₘ₋₁₎ₗ(j) is expressed as follows:

$${\hat{y}}_{( m - 1 ) l} ( j ) = {{{\sum }_{l = 1}}^{L}}_{l \neq l} {\hat{x}}_{( m - 1 ) l} ( i ) * δ ( i + {τ}_{l} ) {\vert}_{i = jS} ,$$

where \hat{x}₍ₘ₋₁₎ₑ(i) is the replica estimated in the stage (m−1) of the signal transmitted on the path l obtained by means of full Nyquist shaping; it is linked to the estimated replica at the output of the stage (m−1) of the standard structure \hat{r}₍ₘ₋₁₎ₑ(i) by the equation (see FIG. 1):

\hat{x}₍ₘ₋₁₎ₑ(i)=\hat{r}₍ₘ₋₁₎ₑ(i)* ψ*(−i).

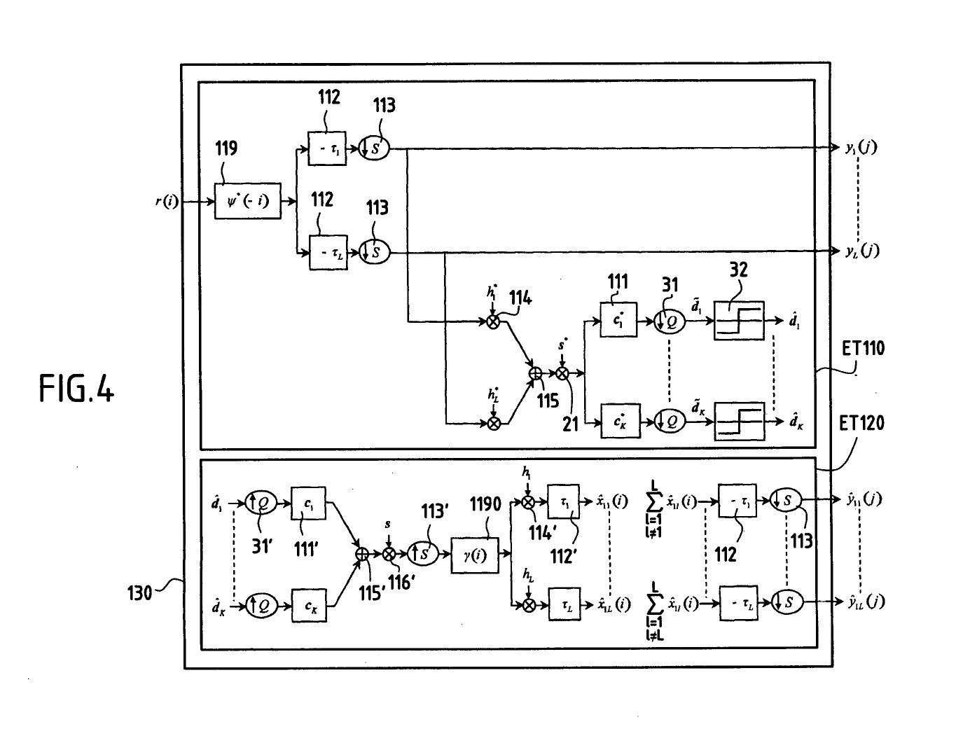

FIG. 4 represents the first stage 130 of the receiver 10 of the invention represented in FIG. 3.

The first stage 130 includes two main blocks, namely a symbol estimator block ET110 and an interference regenerator block ET120.

In this example, the symbol estimator block ET110 consists of a multicode rake receiver with a single correlator filter for each spreading code cₖ (T_{c} structure).

As in the standard structure MPIC receiver 12, the first stage 130 of the receiver 10 of the invention includes, at the output of the filter means 119 adapted to half-Nyquist root discrete shaping of the input signal r(i), means 112 for correcting the delays τ₁, . . . , τ_{L} on the various paths and means 113 for sampling the corrected signals at the chip timing rate T_{c}.

For each path, the signal at the output of the sampling means 113 constitutes the output signal yₗ(j) transmitted to the subsequent stages (see FIG. 3). It is fed to the input of the compensator means 114 of the channel adapted, for each path l, to multiply the signal by the complex conjugate hₗ* of the gain of the corresponding channel on that path.

This channel compensation is effected at the chip timing rate.

The signals on the various paths are then summed by a summator 115.

The signal at the output of the summator 115 is fed to the input of a multiplier 21 which, to descramble it, multiplies the signal chip by chip by the complex conjugate of the scrambling code s*.

The signal from the multiplier 21 is fed to the input of a correlator 111 corresponding to each of the codes C*₁ to C*ₖ of interest.

The signal at the output of each correlator 111 is fed to the input of decimator means 31 adapted to retain one sample every Q chips, which consists in effecting sampling at the symbol timing rate in the analog domain.

A signal consisting of a soft decision in respect of the symbols \tilde{d}₁, . . . , \tilde{d}_{K}, is therefore obtained and is fed to the input of a decision device 32 adapted, for the various spreading codes cₖ, to produce a hard estimate \hat{d}₁, . . . , \hat{d}_{K} of the symbols conveyed by the signal.

In the interference regenerator block ET120 of the first stage 130 of the receiver 10, shaping means 1190 are employed that use full Nyquist shaping γ(i) instead of a half-Nyquist shaping ψ(i).

The Nyquist pulse is assumed to be known in the mobile terminal or, if this is not so, calculated and saved beforehand from the equation:

γ(i)=ψ(i)*ψ*(−i).

Note that in the embodiment described here, some of the processing effected at the input of the symbol estimator block ET11 of the standard structure MPIC 12 (correction of delays by the means 112 and sampling at the chip timing rate by the means 113, see FIG. 2) has been transferred to the output of the interference regenerator block ET120 of the receiver 10 of the invention so as to be able to transmit the interference signals ŷ₁ₗ at the chip timing rate. The interference signal ŷ₁ₗ on the path l is obtained after correcting the delay and sampling at the chip timing rate of the signal resulting from the summation of all the replicas of the signal received on the various paths x₁ₗ(i) . . . x_{1L}(i) except for the path in question.

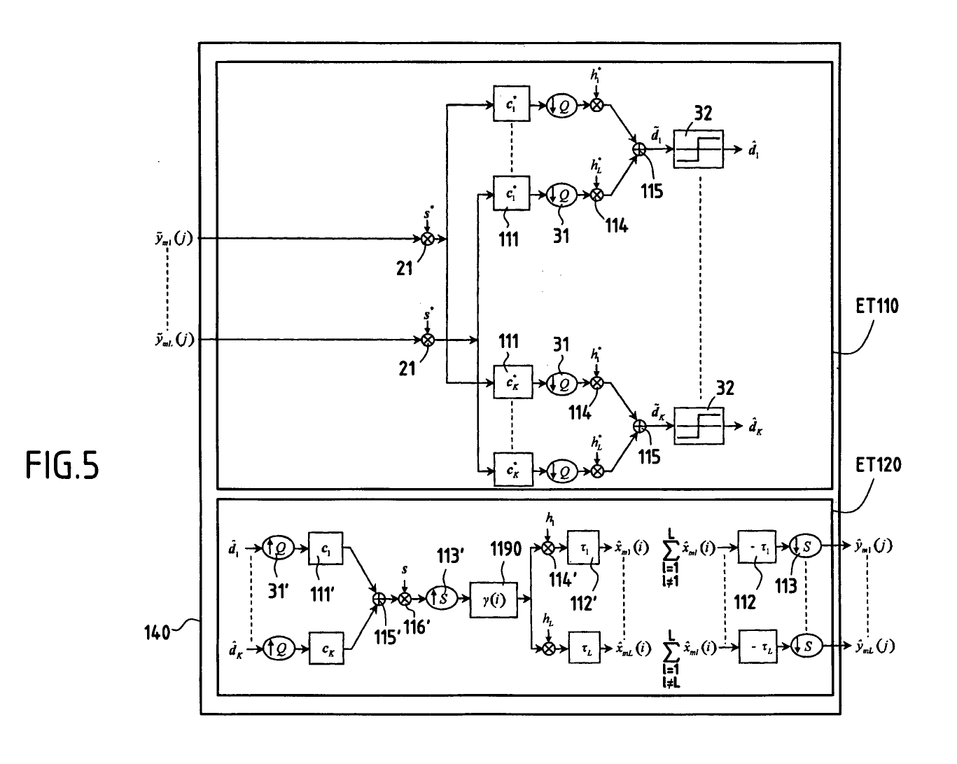

FIG. 5 represents an intermediate stage 140 of level m in the receiver 10 of the invention represented in FIG. 3.

The symbol estimator block ET110 of this intermediate stage 140 has a structure similar to that of the symbol estimator block ET11 of the standard structure MPIC receiver 12 described with reference to FIG. 2.

However, the filter bank 119 at the input of the block ET11 of the standard structure MPIC receiver 12 has been eliminated, as a consequence of using full Nyquist shaping means 1190 in the interference regenerator block ET120, which is highly advantageous.

Note also that the delay corrector means 112 and chip timing rate sampling means 113 have been moved upstream to the output of the interference regenerator block ET120 of the previous stage, as described above with reference to FIG. 4.

The interference regenerator block ET120 of this intermediate stage 140 has a structure identical to that of the interference regenerator block ET120 of the first stage 130 described with reference to FIG. 4.

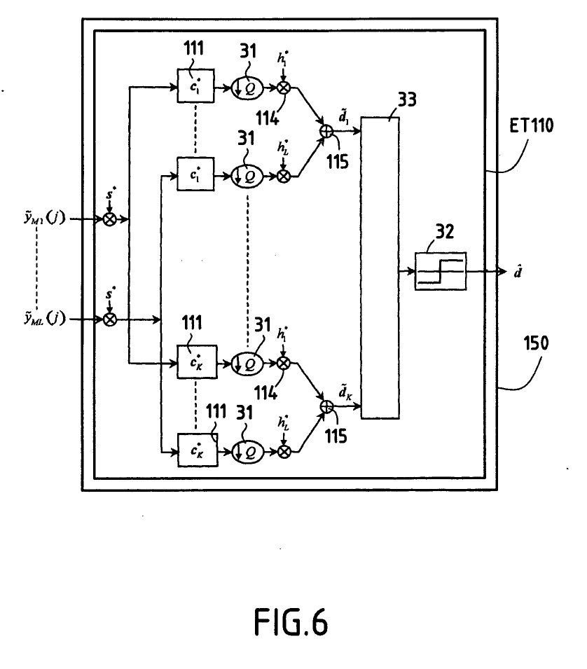

FIG. 6 represents the final stage 150 of the receiver 10 of the invention represented in FIG. 3.

This final stage 150 does not include an interference regenerator block. It includes a symbol estimator block ET110 similar to that of the intermediate stage 140 described with reference to FIG. 5, to which has been added a multiplexing block 33 handling parallel/serial conversion of the estimated symbols for a final decision.

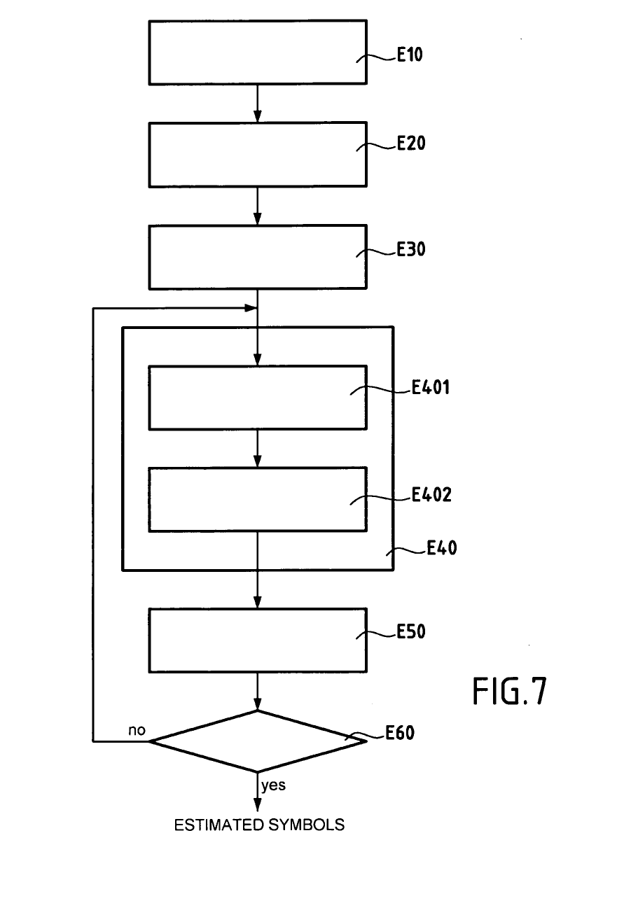

FIG. 7 represents the main steps of a reception method of the invention in the form of a flowchart.

This method can be executed by the receiver 10 of the invention described above.

The reception method of the invention described here includes a step E10 of receiving from a communications channel the analog signal r(t) obtained by spectrum spreading in the base band.

That reception step E10 is followed by a step E20 of producing the received signal on the various paths at the chip timing rate T_{c}. This step is executed using the means 119 adapted to effect filtering adapted to the discrete half-Nyquist root shaping pulse, the delay corrector means 112, and the means 113 for sampling the corrected signals at the chip timing rate T_{c}.

The step E20 of sampling at the chip timing rate is followed by a step E30 of obtaining a first estimate \hat{d}₁, . . . , \hat{d}_{K} of the symbols corresponding to each of the spreading codes C₁ . . . cₖ.

The step E30 of obtaining a first estimate of the symbols is followed by a step E40 during which interference is regenerated for each of the paths on the basis of the estimated symbols (\hat{d}₁, . . . , \hat{d}_{K}) obtained in the previous step E30.

This regeneration step E40 includes two subsets, namely:
a substep E401 for regenerating from the estimated symbols \hat{d}₁, . . . , \hat{d}_{K} replicas \hat{x}₁ₗ,\hat{x}_{1L} of the analog signal corresponding to the various paths; and
a substep E402 during which the interference for each of said paths is regenerated from these replicas \hat{x}₁ₗ,\hat{x}_{1L}.

According to the invention, the interference is regenerated at the chip timing rate and the interference regeneration subset E401 uses full Nyquist shaping.

The interference regeneration step E40 is followed by an interference cancellation step E50 during which a second estimate \hat{d}₂₁,\hat{d}_{2K} of said symbols is obtained by canceling the interference to the analog signal r(t) on each of the paths.

As described above, this is achieved by subtracting from the received signal r(i) all replicas of signals transmitted on the various paths of the channel with the exception of the replica corresponding to the paths in question.

A preferred embodiment of the receiver has more than two stages.

With more than two stages, the additional stages conform to the intermediate stages 140 described above with reference to FIG. 3.

Thus the interference cancellation step E50 is followed by a test E60 during which it is verified whether the current stage is the final stage of the receiver.

If so, the process terminates and the symbols estimated by the process are those \hat{d}₂₁,\hat{d}_{2K} obtained on the second estimation.

If not, the result of the test E60 is negative and the regeneration step E40 and the interference cancellation step E50 are repeated to refine the estimate produced in the subsequent stages.

### Complexity Study

This section discusses a complexity study in terms of complex arithmetic operations that demonstrates the improvement in complexity achieved by the receiver 10 of the invention. The processing of a TTI (transmission time interval) subframe corresponding to a duration of 3 slots in HSDPA mode FDD (frequency division duplex) is discussed. With a spreading factor Q=16, the subframe contains N=3×160=480 symbols. The length in samples of the received discrete signal r(i) depends on the oversampling factor S given by the equation:

P=(NQ−1)S+U+W−1

where U is the half-Nyquist length in samples (the full Nyquist therefore comprises (2U−1) samples) and W is the temporal dispersion in samples of the propagation channel (W=τ_{L} in samples).

The complexity is evaluated below in terms of additions and complex multiplications for the standard structure MPIC receiver 12 and for the receiver 10 of the invention.

Hard-decision operations are not taken into account in evaluating complexity. These operations are identical for both structures and are therefore not affected by complexity reduction. It is important to note that a hard-decision operation for a particular symbol simply amounts to calculating a number of Euclidian distances corresponding to the size of the alphabet of the modulation used and choosing as the decided symbol the element of the alphabet that minimizes this distance.

### 1) Standard Structure MPIC Receiver 12

### Symbol Estimator Block:

| | |
|---|---|
| Half-Nyquist filtering per path: | P × U complex additions |
| | P × U complex multiplications |
| Descrambling per path: | N × Q complex multiplications |
| Despreading per code per path: | N × Q complex additions |
| | N × Q complex multiplications |
| Compensation of channel per code: | N × L complex multiplications |
| Recombination of paths per code: | N × L complex additions |

### Interference Regenerator Block:

| | |
|---|---|
| Spreading per code: | N × Q complex multiplications |
| Combination of codes: | N × Q × K complex additions |
| Scrambling: | N × Q complex multiplications |
| Half-Nyquist shaping: | P × U complex additions |
| | P × U complex multiplications |
| Channel filtering: | P × L complex multiplications |
| Next stage input signal generation: | P × L² complex additions |
| | P × L complex multiplications |

TABLE 1
Complexity of the Tₛ Rake structure

| Complex additions | Complex multiplications |
|---|---|
| P × U + N × K × L × (Q + 1) | P × U + N × L × (Q + Q × K + K) |

TABLE 2
Complexity of the standard structure stage 1

| Complex additions | Complex multiplications |
|---|---|
| P × (2 × U + L²) + | 2 × P × (U + L) + |
| N × K × (Q + Q × L + L) | N × (Q × (K + 1) + L × (Q + Q × K + K)) |

TABLE 3
Complexity of the standard structure stage m (1 < m < M)

| Complex additions | Complex multiplications |
|---|---|
| P × (U + U × L + L²) + | P × (U + U × L + 2 × L) + |
| N × K × (Q + Q × L + L) | N × (Q × (K + 1) + L × (Q + Q × K + K)) |

TABLE 4
Complexity of the standard structure stage M

| Complex additions | Complex multiplications |
|---|---|
| P × U × L + N × K × L × | P × U × L + N × L × (Q + Q × K + K) |
| (Q + 1) | |

### 2) Receiver 10 of the Invention

### Symbol Estimator Block:

| | |
|---|---|
| Half-Nyquist filtering | P × U complex additions |
| (1^{st} stage only): | P × U complex multiplications |
| Descrambling per path: | N × Q complex multiplications |
| First stage: | N × Q complex multiplications |
| Despreading per code per path: | N × Q complex additions |
| | N × Q complex multiplications |
| First stage (per code): | N × Q complex additions |
| | N × Q complex multiplications |
| Compensation of channel per code: | N × L complex multiplications |
| First stage: | N × Q × L complex |
| | multiplications |
| Recombination of paths per code: | N × L complex additions |
| First stage: | N × L complex additions |

### Interference Regenerator Block:

| | |
|---|---|
| Spreading per code: | N × Q complex multiplications |
| Combination of codes: | N × Q × K complex additions |
| Scrambling: | N × Q complex multiplications |
| Full-Nyquist shaping: | P × (2 × U − 1) complex additions |
| | P × (2 × U − 1) complex multiplications |
| Channel filtering: | P × L complex multiplications |
| Next stage | P × L × (L − 1) + N × Q × L complex |
| input signal | additions |
| generation: | N × Q × L complex multiplications |

TABLE 5
Complexity of the T_{c} structure Rake

| Complex additions | Complex multiplications |
|---|---|
| P × U + N × Q × (K + L) | P × U + N × Q × (K + L + 1) |

TABLE 6
Complexity of stage 1 with the new structure

| Complex additions | Complex multiplications |
|---|---|
| P × (3 × U + L × (L − 1) − 1) + | P × (3 × U + L − 1) + |
| N × Q × L × (K + L) | 2 × N × Q × (K + L + 1) |

TABLE 7
Complexity of the stage m (1 < m < M) with the new structure

| Complex additions | Complex multiplications |
|---|---|
| P × (2 × U + L × (L − 1) − 1) + | P × (2 × U + L − 1) + |
| N × (K × L × (Q + 1) + Q × (K + L)) | N × (Q × (K + L + 1) + |
| | L × (Q + Q × K + K)) |

TABLE 8
Complexity of the stage M with the new structure

| Complex additions | Complex multiplications |
|---|---|
| N × K × L × (Q + 1) | N × L × (Q + Q × K + K) |

### Total Complexity for M Stages

TABLE 9
Total complexity for M stages

| | Complex additions | Multiplications complexes |
|---|---|---|
| Standard structure MPIC 12 | $P \times ( \begin{matrix}M \times U + ( M - 1 ) \times U \times L + \\ ( M - 1 ) \times {L}^{2}\end{matrix} ) +$ N × K × (M × (Q + Q × L + L) − Q) | $P \times ( \begin{matrix}M \times U + ( M - 1 ) \times U \times L + \\ 2 \times ( M - 1 ) \times L\end{matrix} ) +$ $N \times ( \begin{matrix}M \times L \times ( Q + Q \times K + K ) + \\ ( M - 1 ) \times Q \times ( K + 1 )\end{matrix} )$ |
| Receiver 10 of the invention | $P \times ( \begin{matrix}( 2 \times M - 1 ) \times U + \\ ( M - 1 ) \times L \times ( L - 1 ) - ( M - 1 )\end{matrix} ) +$ $N \times ( \begin{matrix}M \times Q \times ( K + L ) + \\ ( M - 1 ) \times K \times L \times ( Q + 1 )\end{matrix} )$ | $P \times ( \begin{matrix}( 2 \times M - 1 ) \times U + \\ ( M - 1 ) \times L - ( M - 1 )\end{matrix} ) +$ $N \times ( \begin{matrix}( M - 1 ) \times L \times ( Q + QK + K ) + \\ M \times Q \times ( K + L + 1 )\end{matrix} )$ |

### Application Example

To evaluate the improvement in complexity produced by using the new structure, consider FDD mode HSDPA multicode communication. The parameters used for the application are summarized in Table 10.

TABLE 10
Complexity evaluation parameters.

| | |
|---|---|
| Number of spreading codes | K = 1, . . . , 15 codes |
| Number of symbols | N = 480 symbols |
| Spreading factor | Q = 16 chips |
| Number of MPIC stages | M = 2, 3 and 4 stages |
| UMTS channel | Vehicular-A [ETSI] |
| Number of paths | L = 6 paths |
| Temporal dispersion of the | W = 10 chips |
| channel | |
| Half-Nyquist length | U = 8 chips |
| Oversampling factor | S = 2 and 4 samples |

[ETSI]: TR 101 112, UMTS; Selection procedures for the choice of radio transmission technologies of the UMTS, V.3.2.0 (1998-04), Sophia Antipolis, France.

A complexity comparison between the Tₛ and T_{c} Rake structure is given before setting out the results of a complexity comparison between the standard structure MPIC receiver 12 and the receiver 10 of the invention.

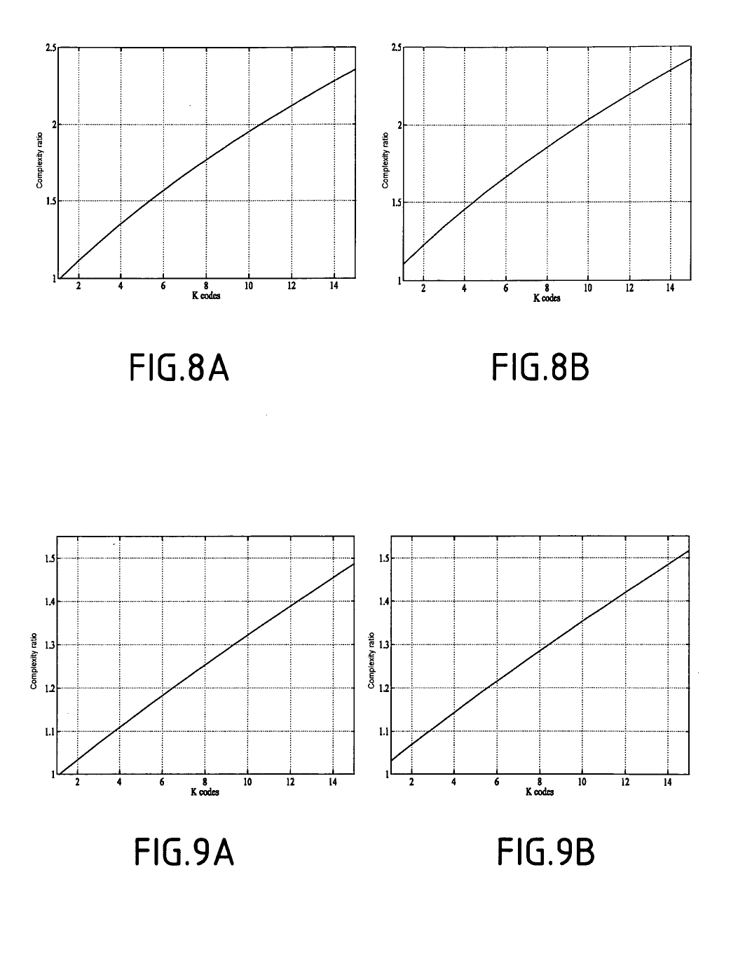

FIGS. 8 and 9 give the Tₛ/T_{c} structure complexity ratio as a function of the number of spreading codes allocated for S=2 and S=4 samples, respectively.

To be more precise:
FIGS. 8A and 9A give the complexity ratio in terms of Tₛ/T_{c} structure complex additions as a function of the number of spreading codes allocated for S=2 and S=4 samples, respectively; and
FIGS. 8B and 9B give the complexity ratio in terms of Tₛ/T_{c} structure complex multiplications as a function of the number of spreading codes allocated for S=2 and S=4 samples, respectively.

The first thing to note is that for the monocode situation (K=1), the Tₛ and T_{c} Rake structures have practically the same complexity. However, once the number of codes allocated increases, the complexity ratio grows in favor of the T_{c} structure.

For example, for K=15 codes, the complexity ratio is 2.5 for S=2 and 1.5 for S=4. It is important to note that the curves of the complexity ratio are of practically the same shape for complex additions and for complex multiplications. On going from S=2 (FIG. 8) to S=4 (FIG. 9), the complexity ratio decreases. It can be shown that this ratio tends to 1 as S becomes very large, independently of the number of codes allocated (see Tables 1 and 5).

The explanation of this behavior is as follows: the improvement obtained by using the T_{c} structure results from the reduced number of correlators (filters adapted to the spreading codes) and consequently optimization of the amount of processing effected at the chip timing rate.

In contrast, increasing the oversampling factor S amounts to increasing the amount of processing effected at the fast timing rate. This processing is exactly the same for both structures (see Tables 1 and 5), and becomes dominant when S is large.

In practice the oversampling factor S takes relatively low values of 2, 4 and 8 at the most, whence the benefit of using a T_{c} structure for the Rake in the first stage of the receiver 10 of the invention, instead of a Tₛ structure.

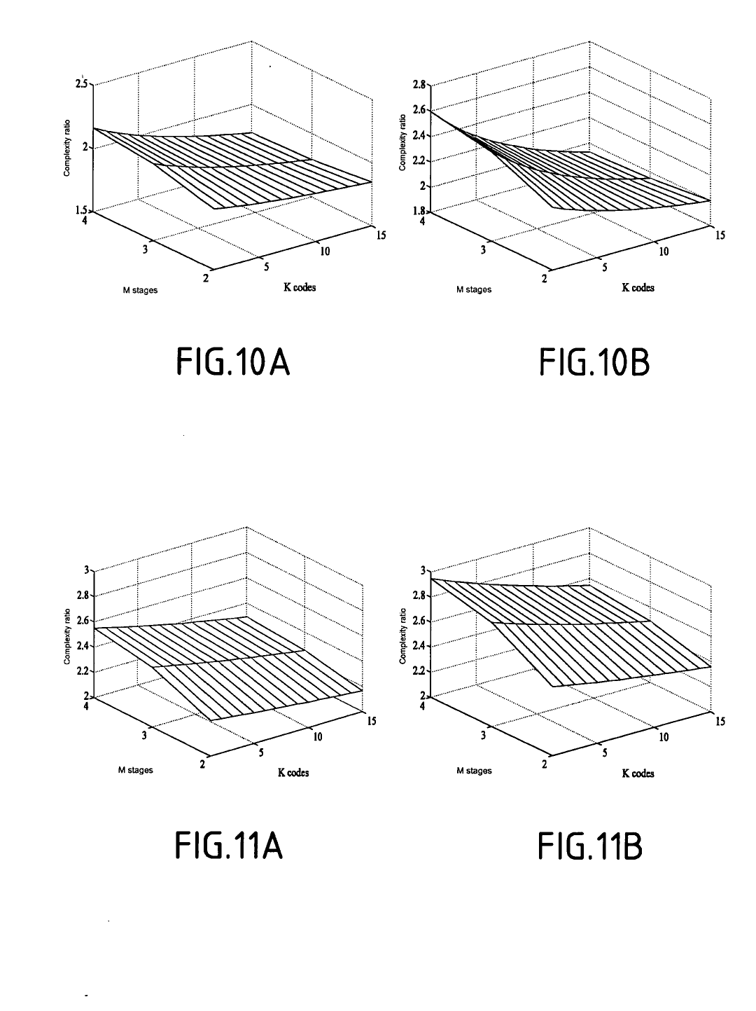

FIGS. 10 and 11 give the complexity ratio for the standard structure MPIC 12/receiver 10 of the invention as a function of the number of codes allocated and the number of stages constituting the MPIC for S=2 (FIG. 10) and S=4 (FIG. 11).

To be more precise:
FIGS. 10A and 11A give the complexity ratio in terms of standard MPIC/invention structure complex additions as a function of the number of codes allocated and the number of stages for S=2 and S=4 samples, respectively; and
FIGS. 10B and 11B give the complexity ratio in terms of standard MPIC/invention structure complex multiplications as a function of the number of codes allocated and the number of stages for S=2 and S=4 samples, respectively.

These results show that the new structure reduces complexity compared to the standard structure MPIC by a factor of 2 to 3.

This ratio is proportional to the oversampling factor. This behavior is the result of the fact that for the new structure optimizing complexity concerns the processing effected at the fast timing rate.

Moreover, the complexity ratio increases in direct proportion to the number of stages, which is entirely logical given the principle on which reducing complexity for the new structure is based.

In contrast, a slight reduction in the improvement of complexity is observed on increasing the number of codes allocated, as this increases the amount of the processing effected at the chip timing rate relative to that effected at the fast timing rate. Tables 11 and 12 below show the order of magnitude of the number of complex arithmetic operations necessary for the two MPIC structures.

TABLE 11
Complexity of the MPIC with standard structure and new
structure as a function of the number of codes allocated
and the number of stages for S = 2 samples

| K | M | Operation | Standard | New | Ratio |
|---|---|---|---|---|---|
| codes | stages | (complex) | structure | structure | (standard/new) |
| 5 | 2 | Addition | 3175768 | 1645280 | 1.9302 |
| | | Multiplication | 2906152 | 1337264 | 2.1732 |
| | | Arithmetic | 6081920 | 2982544 | 2.0392 |
| | 3 | Addition | 5845038 | 2944382 | 1.9851 |
| | | Multiplication | 5259726 | 2320670 | 2.2665 |
| | | Arithmetic | 11104764 | 5265052 | 2.1091 |
| | 4 | Addition | 8514308 | 4243484 | 2.0064 |
| | | Multiplication | 7613300 | 3304076 | 2.3042 |
| | | Arithmetic | 16127608 | 7547560 | 2.1368 |
| 10 | 2 | Addition | 3703768 | 1966880 | 1.8831 |
| | | Multiplication | 3434152 | 1658864 | 2.0702 |
| | | Arithmetic | 7137920 | 3625744 | 1.9687 |
| | 3 | Addition | 6656238 | 3549182 | 1.8754 |
| | | Multiplication | 6070926 | 2925470 | 2.0752 |
| | | Arithmetic | 12727164 | 6474652 | 1.9657 |
| | 4 | Addition | 9608708 | 5131484 | 1.8725 |
| | | Multiplication | 8707700 | 4192076 | 2.0772 |
| | | Arithmetic | 18316408 | 9323560 | 1.9645 |
| 15 | 2 | Addition | 4231768 | 2288480 | 1.8492 |
| | | Multiplication | 3962152 | 1980464 | 2.0006 |
| | | Arithmetic | 8193920 | 4268944 | 1.9194 |
| | 3 | Addition | 7467438 | 4153982 | 1.7977 |
| | | Multiplication | 6882126 | 3530270 | 1.9495 |
| | | Arithmetic | 14349564 | 7684252 | 1.8674 |
| | 4 | Addition | 10703108 | 6019484 | 1.7781 |
| | | Multiplication | 9802100 | 5080076 | 1.9295 |
| | | Arithmetic | 20505208 | 11099560 | 1.8474 |

TABLE 12
Complexity of the standard structure MPIC and new structure
as a function of the number of codes allocated and
the number of stages for S = 4 samples

| K | M | Operation | Standard | New | Ratio |
|---|---|---|---|---|---|
| codes | stages | (complex) | structure | structure | (standard/new) |
| 5 | 2 | Addition | 9764400 | 4354624 | 2.2423 |
| | | Multiplication | 9125328 | 3677152 | 2.4816 |
| | | Arithmetic | 18889728 | 3677152 | 2.3519 |
| | 3 | Addition | 18267996 | 7608764 | 2.4009 |
| | | Multiplication | 16943772 | 6246140 | 2.7127 |
| | | Arithmetic | 35211768 | 6246140 | 2.5415 |
| | 4 | Addition | 26771592 | 10862904 | 2.4645 |
| | | Multiplication | 24762216 | 8815128 | 2.8091 |
| | | Arithmetic | 51533808 | 8815128 | 2.6188 |
| 10 | 2 | Addition | 10292400 | 4676224 | 2.2010 |
| | | Multiplication | 9653328 | 3998752 | 2.4141 |
| | | Arithmetic | 19945728 | 8674976 | 2.2992 |
| | 3 | Addition | 19079196 | 8213564 | 2.3229 |
| | | Multiplication | 17754972 | 6850940 | 2.5916 |
| | | Arithmetic | 36834168 | 15064504 | 2.4451 |
| | 4 | Addition | 27865992 | 11750904 | 2.3714 |
| | | Multiplication | 25856616 | 9703128 | 2.6648 |
| | | Arithmetic | 53722608 | 21454032 | 2.5041 |
| 15 | 2 | Addition | 10820400 | 4997824 | 2.1650 |
| | | Multiplication | 10181328 | 4320352 | 2.3566 |
| | | Arithmetic | 21001728 | 9318176 | 2.2538 |
| | 3 | Addition | 19890396 | 8818364 | 2.2556 |
| | | Multiplication | 18566172 | 7455740 | 2.4902 |
| | | Arithmetic | 38456568 | 16274104 | 2.3631 |
| | 4 | Addition | 28960392 | 12638904 | 2.2914 |
| | | Multiplication | 26951016 | 10591128 | 2.5447 |
| | | Arithmetic | 55911408 | 23230032 | 2.4069 |

### Application of the Invention

The field of application of the invention is that of advanced receivers for 3G and later mobile terminals. The MPIC structure proposed by the invention enables it to be implemented for HSDPA mobile terminals. The complexity of the MPIC using this new structure is compatible with the performance obtained.

Although discussed in detail here for the downlink, the new structure can be used for an uplink (i.e. at the base stations), which is where interference cancellers originated. In fact, the proposed reception structure can be used in any wireless communications system using the CDMA access technique requiring advanced processing and where a significant proportion of the spreading codes are known (for example, systems using multicode).

What is claimed is:

1. A receiver for receiving from a multipath propagation channel an analog base-band spread-spectrum signal) conveying symbols, said receiver having a structure with at least two stages each including a symbol estimator block and, with the exception of the final stage, an interference regenerator block using the symbols estimated by the symbol estimator block of said stage, wherein the signals are transmitted at the chip timing rate from one stage to another and each of said interference regenerator blocks uses full Nyquist shaping.

2. A receiver according to claim 1, wherein said symbol estimator block of the first stage consists of a multicode Rake receiver including a single despreading correlator filter for each of said codes and wherein channel compensation is effected at the chip timing rate.

3. An iterative method of receiving from a multipath propagation channel an analog base-band spread-spectrum signal) conveying symbols, said method including:
a step of obtaining a first estimate \hat{d}₁, . . . , \hat{d}_{K} of said symbols corresponding to each of said codes c₁ . . . cₖ;
a step of regenerating interference for each of said paths from said estimated symbols \hat{d}₁, . . . , \hat{d}_{K}; and
an interference cancellation step for delivering a second estimate \hat{d}₂₁,\hat{d}_{2K} of said symbols by canceling said interference from said analog signal) for each of said paths, wherein said interference is regenerated at the chip timing rate and said interference regenerator step uses full Nyquist shaping.

4. A computer program including instructions for executing steps of the reception method of claim 3 when said program is executed by a computer.

5. A storage medium readable by a computer on which is stored a computer program comprising instructions for executing steps of the reception method according to claim 3.
